(19) United States
(12) Patent Application Publication
(10) Pub. No.: US 2024/0037457 A1
(43) Pub. Date: Feb. 1, 2024

(54) Cloud Based Early Warning Drift Detection

(71) Applicant: Oracle International Corporation, Redwood Shores, CA (US)

(72) Inventors: Dwijen BHATTACHARJEE, Karnataka (IN); Hari Bhaskar SANKARANARAYANAN, Bangalore (IN); Divyank GUPTA, Kota (IN)

(21) Appl. No.: 17/877,139

(22) Filed: Jul. 29, 2022

(51) Int. Cl. G06N 20/20; G06K 9/62; G06N 5/04; H04L 67/133

(52) U.S. Cl. CPC G06N 20/20; G06K 9/6277; G06K 9/6262; G06N 5/04; H04L 67/133

(57) ABSTRACT

Embodiments detect data drift associated with machine learning (“ML”) models. Embodiments identify a first feature stored by a feature store, where the feature store includes an offline store and an online store. Embodiments determine one or more first trained ML models that are using the first feature. For each of the first trained ML models, embodiments invoke the first trained ML model using synthetic data or validation data, generate metrics to determine an accuracy of the first trained ML model and, when the accuracy is below a threshold, generate an alert notifying of a first data drift for the first trained ML model.

One embodiment is directed generally to a computer system, and in particular to a machine learning model and feature store hosted in a cloud based computer system.

### BACKGROUND INFORMATION

Cloud service providers provide various services in the “cloud”, meaning over a network, such as the public Internet, and remotely accessible to any network-connected client device. Examples of the services models used by cloud service providers (also referred to herein as “cloud providers” or “providers”) include infrastructure as a service (“IaaS”), platform as a service (“PaaS”), software as a service (“SaaS”), and network as a service (“NaaS”). IaaS providers provide customers with infrastructure resources such as processing, storage, networks, and other computing resources that the customer is able to use to run software. The customer does not manage the infrastructure, but has control over operating systems, storage, and deployed applications, among other things, and may be able to control some networking components, such as firewalls. PaaS providers provide a customer with a platform on which the customer can develop, run, and manage an application without needing to maintain the underlying computing infrastructure. SaaS is a software licensing and delivery model in which software is licensed to a customer on a subscription basis, and is centrally hosted by the cloud provider. Under this model, applications can be accessed, for example, using a web browser. NaaS providers provide network services to customers, for example, by provisioning a virtual network on the network infrastructure operated by another party. In each of these service models, the cloud service provider maintains and manages the hardware and/or software that provide the services, and little, if any, software executes on a user's device.

Customers of cloud service providers, which are also referred to herein as users and tenants, can subscribe to the service provider to obtain access to the particular services provided by the service provider. The service provider can maintain an account for a user or tenant through which the user and/or tenant can access the provider's services. The service provider can further maintain user accounts that are associated with the tenant, for individual users.

One functionality that may be supported by a cloud service provider is the training and implementation of machine learning (“ML”) models. ML models, in general, after being trained, provide predictions based on newly provided data. However, ML models can run into issues related to “data drift” when deployed using real-world current data. Data drift occurs when ML models are passed new inputs that include new values or a skew in data that is no longer representative of the distribution of data in the offline training dataset, or which are not present in training datasets, or new data that is not representative of the training data. This may occur because of a sample selection bias, or because of non-stationary environments wherein the data changes because of a variety of factors, including but not limited to, instances where an adversary tries to work around the existing classifier's learned concepts, or where new data is simply not representative of training data. In other instances, data drift may occur, for example, because of changes in population distribution over time, changes in distribution of a class variable, or changes to definitions of a class (i.e., a changing context that can induce changes in target concepts).

### SUMMARY

Embodiments detect data drift associated with machine learning (“ML”) models. Embodiments identify a first feature stored by a feature store, where the feature store includes an offline store and an online store. Embodiments determine one or more first trained ML models that are using the first feature. For each of the first trained ML models, embodiments invoke the first trained ML model using synthetic data or validation data, generate metrics to determine an accuracy of the first trained ML model and, when the accuracy is below a threshold, generate an alert notifying of a first data drift for the first trained ML model.

### BRIEF DESCRIPTION OF THE DRAWINGS

Further embodiments, details, advantages, and modifications will become apparent from the following detailed description of the embodiments, which is to be taken in conjunction with the accompanying drawings.

FIG. 1 illustrates an example of a system that includes an ML data and inference drift detection layer system in accordance to embodiments.

FIG. 2 is a block diagram of the ML data and inference drift detection layer system of FIG. 1 in the form of a computer server/system in accordance with an embodiment of the present invention.

FIG. 3 is a block/flow diagram of a portion of the system that includes the ML feature store with drift detection layer system 10 and related components in accordance to embodiments of the invention.

FIG. 4 illustrates metrics generated by a drift detector in accordance to one embodiment.

FIGS. 5-8 illustrate an example cloud infrastructure that can incorporate the secure on-premises to cloud connector framework system in accordance to embodiments.

### DETAILED DESCRIPTION

One embodiment detects data drift at a cloud based feature store or of a trained machine learning model using an offline drift detector as well as an online inference detector. Embodiments allow the data drift to be detected before the data drift impacts predictions from production models.

“Data drift” includes “concept drift”, which means that the statistical properties of the target variable, which the machine learning (“ML”) model is trying to predict, changes over time in unforeseen ways. This causes problems because the predictions become less accurate as time passes. The measurement and/or detection of data drift is a complicated process in ML operations and most of the time it is captured as “post the fact”, particularly for concept drift. Some known solutions detect the drift at the data integration stage. However, this may not be fully captured if the ML model uses features in the downstream feature engineering process.

For example, a data scientist can create features out of raw data and store them in a feature store. A transformation is run on the data to get the feature (e.g., Credit score>700 captured as a feature computation to a feature named “Credit track record”). Embodiments measure the drift early at the feature level and provide signals to the ML engineers even before the drift happens so that it can be a proactive measure for them to deep dive or discard based on the drift signal findings. Specifically, in embodiments, data enters the feature store and then the same data fed to train one or more models. In embodiments, when data is ingested in the feature store, a series of tests are run to detect the drift. If the data has been drifted in the feature store, the test will detect it and the same data set will not be fed/available for training the models, therefore preventing model drift.

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

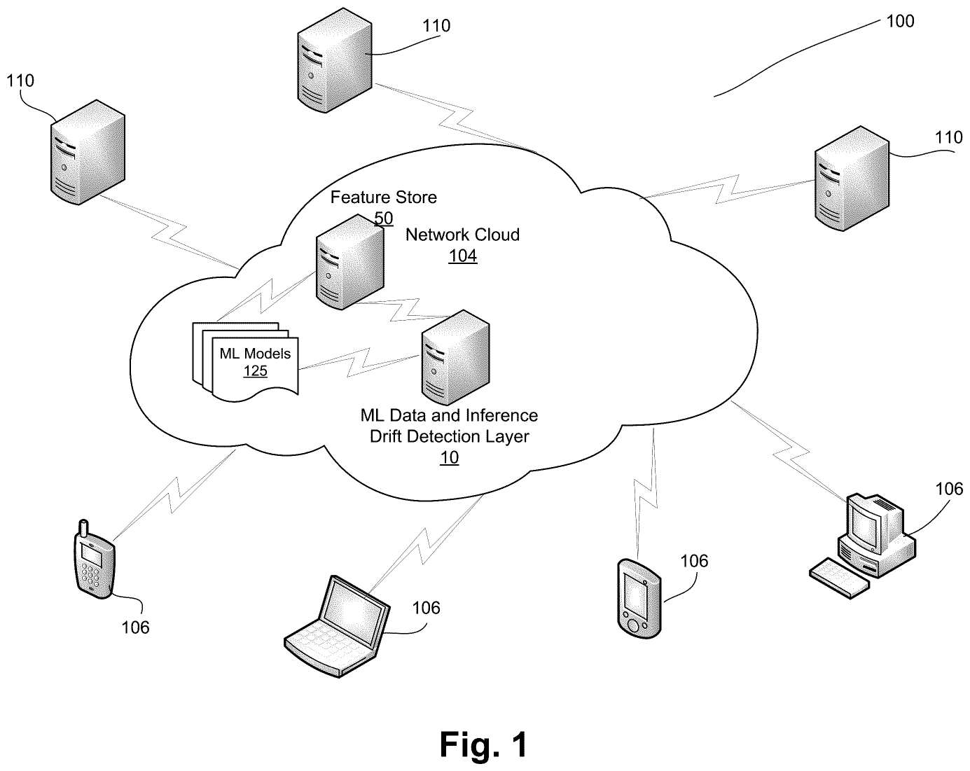

FIG. 1 illustrates an example of a system 100 that includes an ML data and inference drift detection layer system 10 in accordance to embodiments. ML data and inference drift detection layer system 10 may be implemented within a computing environment that includes a communication network/cloud 104. Network 104 may be a private network that can communicate with a public network (e.g., the Internet) to access additional services 110 provided by a cloud services provider. Examples of communication networks include a mobile network, a wireless network, a cellular network, a local area network (“LAN”), a wide area network (“WAN”), other wireless communication networks, or combinations of these and other networks. ML data and inference drift detection layer system 10 may be administered by a service provider, such as via the Oracle Cloud Infrastructure (“OCI”) from Oracle Corp.

Tenants of the cloud services provider can be organizations or groups whose members include users of services offered by service provider. Services may include or be provided as access to, without limitation, an application, a resource, a file, a document, data, media, or combinations thereof. Users may have individual accounts with the service provider and organizations may have enterprise accounts with the service provider, where an enterprise account encompasses or aggregates a number of individual user accounts.

System 100 further includes client devices 106, which can be any type of device that can access network 104 and can obtain the benefits of the functionality of ML data and inference drift detection layer system 10 of detecting data drift of ML models. As disclosed herein, a “client” (also disclosed as a “client system” or a “client device”) may be a device or an application executing on a device. System 100 includes a number of different types of client devices 106 that each is able to communicate with network 104.

Executing on cloud 104 are one or more ML models 125. Each ML model 125 can be executed by a customer of cloud 104. In embodiments, an ML model 125 can be accessible to a client 106 via a representational state transfer application programming interface (“REST API”) and function as an endpoint to the API. ML models 125 can by any type of machine learning model that, in general, is trained on some training data and validation data and then can process additional incoming “live” data to make predictions. Examples of ML models 125 include artificial neural networks (“ANN”), decision trees, support-vector machines (“SVM”), Bayesian networks, etc. Training data can be any set of data capable of training ML model 125 (e.g., a set of features with corresponding labels, such as labeled data for supervised learning). In embodiments, training data can be used to train a ML model 125 to generate a trained ML model 125.

Part of layer 10 may be incorporated in a feature store 50, also hosted by cloud 104. In general, a feature store encompasses the domain knowledge within the cloud based applications which makes it richer to build and access. In machine learning and pattern recognition, a “feature” is an individual measurable property or characteristic of a phenomenon. Choosing informative, discriminating and independent features is a crucial element of effective algorithms in pattern recognition, classification and regression. In data science, a “feature store” can provide a single pane of glass for sharing all available features. When a data scientist starts a new project, he or she can go to the feature store, functioning in part as a catalog, and easily find the features they are looking for. However, a feature store is not only a data layer. It is also a data transformation service enabling users to manipulate raw data and store it as features ready to be used by any machine learning model.

In contrast to generally known feature stores, feature store 50 also incorporates/integrates drift detection functionality disclosed herein.

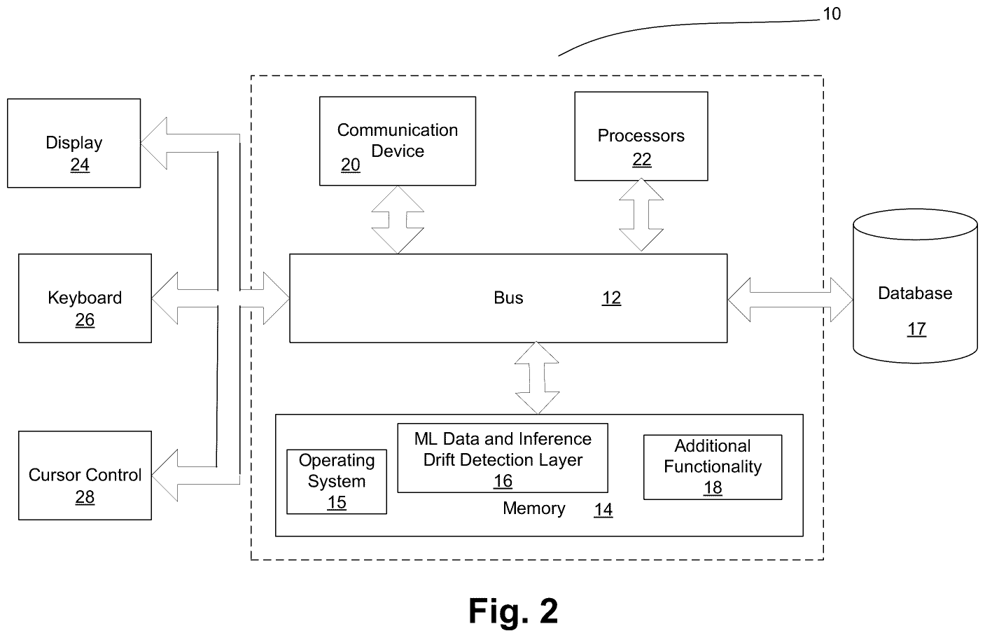

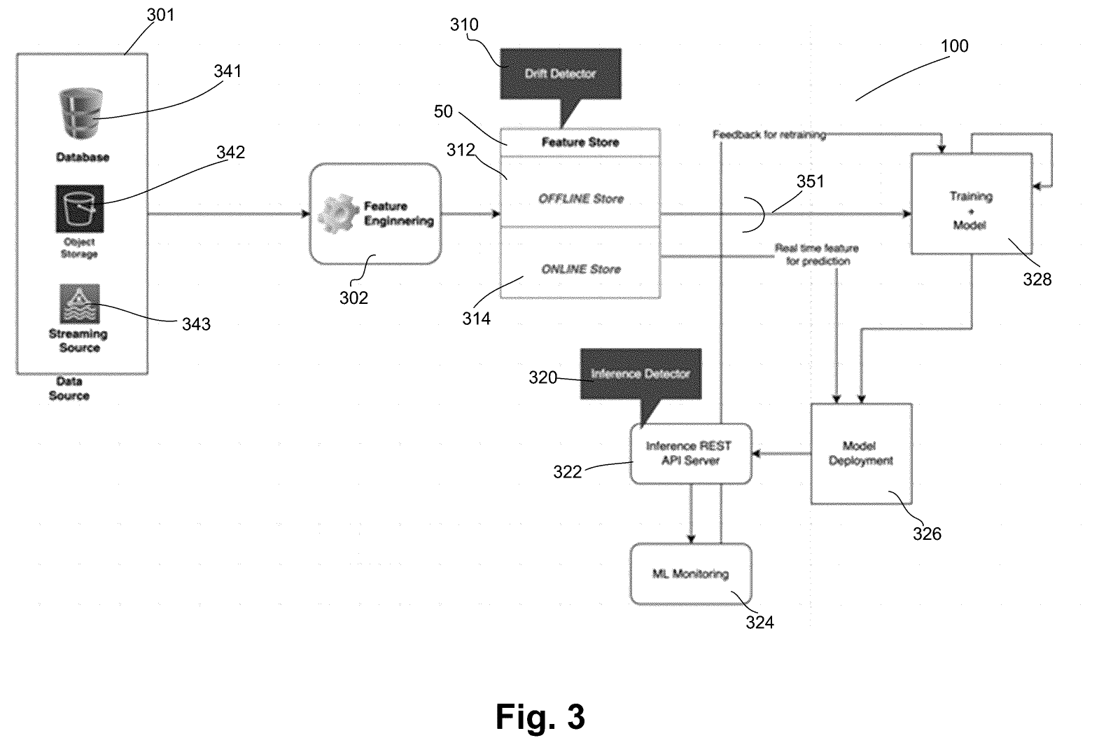

FIG. 2 is a block diagram of an ML data and inference drift detection layer system 10 of FIG. 1 in the form of a computer server/system 10 in accordance with an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. One or more components of FIG. 2 can also be used to implement any of the elements of FIG. 1 and FIG. 3, discussed below. Further, system/layer 10 is integrated with other elements, such as feature store 50 and/or a REST API server disclosed below.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include an ML data and inference draft detection layer module 16 that detects data drift of ML models, and all other functionality disclosed herein. System 10 can be part of a larger system. Therefore, system 10 can include one or more additional functional modules 18 to include the additional functionality, such as any other functionality provided by the Oracle Cloud Infrastructure (“OCI”) from Oracle Corp. A file storage device or database 17 is coupled to bus 12 to provide centralized storage for modules 16 and 18, including data regarding previous schema mappings. In one embodiment, database 17 is a relational database management system (“RDBMS”) that can use Structured Query Language (“SQL”) to manage the stored data.

In one embodiment, database 17 is implemented as an in-memory database (“IMDB”). An IMDB is a database management system that primarily relies on main memory for computer data storage. It is contrasted with database management systems that employ a disk storage mechanism. Main memory databases are faster than disk-optimized databases because disk access is slower than memory access, the internal optimization algorithms are simpler and execute fewer CPU instructions. Accessing data in memory eliminates seek time when querying the data, which provides faster and more predictable performance than disk.

In one embodiment, database 17, when implemented as an IMDB, is implemented based on a distributed data grid. A distributed data grid is a system in which a collection of computer servers work together in one or more clusters to manage information and related operations, such as computations, within a distributed or clustered environment. A distributed data grid can be used to manage application objects and data that are shared across the servers. A distributed data grid provides low response time, high throughput, predictable scalability, continuous availability, and information reliability. In particular examples, distributed data grids, such as, e.g., the “Oracle Coherence” data grid from Oracle Corp., store information in-memory to achieve higher performance, and employ redundancy in keeping copies of that information synchronized across multiple servers, thus ensuring resiliency of the system and continued availability of the data in the event of failure of a server.

FIG. 3 is a block/flow diagram of a portion of system 100 that includes ML feature store with drift detection layer system 10 (shown as drift detector 301 and/or inference detector 320) and related components in accordance to embodiments of the invention.

System 100 includes one or more data sources 301. “Raw” data is stored in different data sources 301, such as a database 341, an object storage service (“OSS”) 342, a streaming service 343, a file system (not shown), a data lake (i.e., centralized repository designed to store, process, and secure large amounts of structured, semi-structured, and unstructured data) (not shown), etc.

Feature extraction/engineering is performed at 302 and the generated features are stored in feature store 50. Generating a new feature via feature engineering can require a large amount of work. Due to different requirements during training and serving, features are kept in an offline store 312 (for offline or batch processing) or an online store 314 (for real-time processing) part of feature store 50. A user may decide where to store the features. A user can choose to ingest in both, but in general most recent features are stored in online while offline contains all historic feature values. Online feature store 314 serves online applications with data at a low-latency, such as “MySQL.” Offline feature store 312 in embodiments includes scale-out SQL databases that provide data for developing AI models and make feature governance possible for explainability and transparency, such as “Hive.”

Feature store 10, in general, is a data management layer for machine learning that allows to users to share discovered/generated features and create more effective machine learning pipelines. Feature store 50, in embodiments, further includes a data drift layer that provides that data drift detection functionality disclosed herein. Features are considered any measurable input that can be used in a predictive model (i.e., any type of ML or artificial intelligence model). For example, a recommendation application may use the total amount per purchase or product category as one of its many features. Features are used to train ML models and make predictions. In general, the more data, the better the predictions.

The features also need to be organized in order to make sense. The data for the features needs to be pulled from somewhere (i.e., data source 301) and the features need to be stored after being computed for an ML pipeline to be able to use the features. Feature store 50 is where the features are stored and organized for the explicit purpose of being used to either train models or make predictions (by applications that have a trained model). Feature store 50 is a central location within cloud 104 where groups of features can either be updated or created from multiple different data sources, new datasets can be created or updated from those feature groups for training models or for use in applications that do not want to compute the features but just retrieve them when it needs them to make prediction

After being created and stored, in embodiments at 351 the engineered features are pulled from offline feature store 312 for model training at 328. In general, a model is trained using both a training dataset and a validation dataset. Once the performance of the model is satisfied (e.g., via automated testing or determined by a data scientist), the model is deployed at 326. Model deployment module 326 is responsible for creating infrastructure in order to host the selected model in a production environment and provides an endpoint via cloud 104 from which user of the models, via one or more of clients 106, provides calls to get the prediction result. The endpoint is accessed via an inference representational state transfer application programming interface (“REST API”) server 322.

REST API server 322 includes one or more servers hosted on cloud 104 that allows each of clients 106 to obtain web resources/services (e.g., provided by servers 110 and server 10). In a RESTful Web service (i.e., a service obtained via a REST API), requests made to a resource's URI elicit a response with a payload formatted in HTML, XML, JSON, or some other format. For example, the response can confirm that the resource state has been changed. The response can also include hypertext links to related resources. The most common protocol for these requests and responses is HTTP. It provides operations (HTTP methods) such as OPTIONS, GET, POST, PUT, PATCH and DELETE. In embodiments, the REST API request includes inference data that is received by one or more ML models 326, which in return provide a prediction.

In general, for an ML model, in the training phase, a developer feeds their model a curated dataset so that it can “learn” everything it needs to about the type of data it will analyze. Then, in the inference phase (initiated via REST API 322 by a client), the model can make predictions based on live data to produce actionable results.

System 150 further includes an ML monitoring module 324 that monitors different metrics to capture the model performance and key performance indicator (“KPI”) metrics.

Embodiments further include a drift detector 310 that is integrated into the offline store portion of feature store 50 as part of the data drift layer. In embodiments, features are generated from raw data 301 via the feature engineering process 302 and published in feature store 50 at scheduled intervals for batch data. When the pipeline (i.e., feature engineering process 302) generates a new feature value, it notifies drift detector 310 to begin processing. Drift detection by drift detector 310 in embodiments is performed on a feature-by-feature basis each time the feature definition pipeline is executed. A new version of the feature is generated when feature definition (transformation logic) changes. Drift detection would happen every time a feature definition pipeline runs both for a new feature version or raw data ingestion.

Raw data can include a column such as gender having values as “Male”, “Female”, “Prefer Not to say” which can be mapped to a feature with a name “gender_encoded” having values as 0, 1, 2 respectively. Here, “gender_encoded” is the feature and 0, 1, 2 are feature values. In embodiments, drift may be detected if a new feature value of, for example, 4, is detected. Similarly, drift may be detected is only a value 0 for the gender_encoded feature is detected instead of a variety of values.

For example, for a deployed model, a dataset has been used to train the model. Drift detector 310 compares the training dataset with the new dataset using samples of data to detect anomalies between the datasets. The training dataset contains actual features instead of raw data. In certain scenarios, a feature may be the same as raw data when no transformation or feature engineering is performed on the raw data, but that is not typically the case. As features are fed as input into a model (as opposed to raw data), drift detection should happen at the feature level. Due to the feature engineering and extraction process, a drift in raw data might get suppressed or changed, resulting in no deviation in the underlying feature.

Drift detector 310 processes the data and generates a series of metrics to detect any drift. Data drift can be identified using sequential analysis methods, model-based methods, and time distribution-based methods. Sequential analysis methods such as DDM (drift detection method)/EDDM (early DDM) rely on the error rate to identify the drift detection. A model-based method uses a custom model to identify the drift. Time distribution-based methods use statistical distance calculation methods to calculate drift between probability distributions.

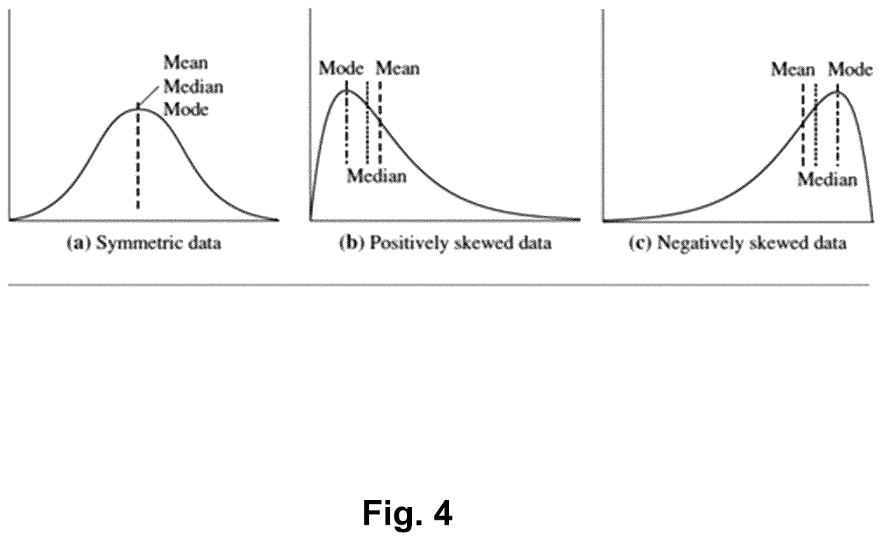

FIG. 4 illustrates metrics generated by drift detector 310 in accordance to one embodiment. As shown in FIG. 4, the metrics include a mean, median and mode check to detect any skewed data. In embodiments, every time the feature definition pipeline is run, drift detector 310 will compute statistical properties such as mean, median, mode etc. on the features (i.e., old feature values vs. new feature values) and compare it with previously computed statistic metrics for the features. In other embodiments, other analysis can be done automatically such as boxplot analysis for outliers detection, concept drift due to change in statistical properties of data with time, etc.

Other embodiments use one or more of the following methodologies to detect data by determining the difference between any 2 populations (e.g., old feature values vs. new feature values) include: (1) Kolmogorov-Smirnov (K-S) test, (2) Population Stability Index; (3) Page-Hinkley method, etc.

In general, whenever an execution of a feature pipeline finishes, it will notify drift detector 310 system about its completion. Drift detector 310 will then run series of test to see is there is the occurrence of any data drift. A feature pipeline (e.g., feature engineering pipeline 302) runs the logic of converting raw data into user defined features. Therefore, the execution of the pipeline terminating results in new feature values being available. In one embodiment, the next step is for drift detector 310 to determine drift, and then get ingested into the offline feature store if no drift.

If any drift is detected by drift detector 310, it will attach a tag with the new version of feature, marking it with a potential data drift label. Embodiments include a quality gate 351 on the link between offline store 312 and model training 328 which will block any feature, on a per feature basis, with the data drift label tag to get consumed further downstream in the pipeline. If no drift detection is found, gate 351 will open and the features will be ready to get consumed by production models for model training at 328.

In other embodiments, drift detector 310 will implement a predefined series of detection tests will also include an option for users to attach their own drift detection custom test logic as a plug and play module.

System 100 further includes an inference detector 320. In embodiments, inference detector 320 is a separate component from feature store 50 and is integrated with server 322. Machine learning inference is the process of running data points into a machine learning model to calculate an output, such as a single numerical score or other type of prediction. Specifically, once one or more of models 326 are deployed in production, each deployed model provides an endpoint 322 via which a client can call with an input vector to get the prediction result.

When multiple models 326 are implemented, there may be instances that one of the features stored in feature store 50 is used by multiple ML models 125 and all or some of the models are deployed in production (i.e., having an endpoint available for clients to make a prediction call/request via REST API server 322).

Embodiments, using feature store 50, identify what features are used by which models and then, via a model store/catalog in embodiments, which model deployments are using the model. A model store/catalog is a centralized repository of machine learning models and ensure that model artifacts are immutable and allows data scientists to share models, and reproduce them as needed. After a model is stored in the model store/catalog, it can be deployed as an HTTP endpoint using a model deployments resource. Using a feature means which input features were used to train the model. Therefore, embodiments retrieve all the endpoints in which the feature is being used indirectly (i.e., which endpoints are using the feature store). An endpoint is the HTTP endpoint where the model is deployed and serving inference requests. Embodiments determine all model deployment endpoints that are using a particular feature.

In one embodiment, inference detector 320 generates some synthetic data for a particular feature. Synthetic data is artificial data that mimics real-world observations and is used to train machine learning models when actual data is difficult or expensive to get. In embodiments, a “python” package can be used to generate synthetic data from real data used as a reference. In other embodiments, inference detector 320 gets a validation data set from offline store 312 to use (i.e., data that passes through quality gate 351 by drift detector 312). A validation dataset is the sample of data used to provide an unbiased evaluation of a model fit on the training dataset while tuning model hyperparameters. The evaluation becomes more biased as the skill on the validation dataset is incorporated into the model configuration. The validation set is used to evaluate a given model, but this is for frequent evaluation. Validation data is also used to fine-tune the model hyperparameters. Therefore, the model occasionally sees this data, but it never “learns” from it. Therefore, the validation set affects a model, but only indirectly.

Inference detector 320 then randomly selects some endpoints from the list of endpoints that are using the feature. In embodiments, inference detector runs as a scheduled job on a pre-defined time interval.

In embodiments, inference detector 320 invokes a randomly selected endpoint and captures a series of metrics reflecting the accuracy of the model (e.g., an AUC curve (i.e., area under the ROC curve), precision, recall etc.) and capture the information in a database.

If the newly calculated metrics are below some threshold (for example AOC is less than some threshold value AOCX or Precision is below X, etc.), inference detector 320 can trigger an alert which will notify the data scientist about possible drift of the data in production. Inference detector 320 can also get similar feedback information from ML monitoring system 324, such as when KPI metrics for recommendation link click conversion goes below 30%, to trigger the alarm.

Therefore, inference detector 320 proactively determines models that are not performing well before the models are implemented in production.

As an example of the functionality of system 100, assume a retail store uses machine learning models that are implemented by cloud 104 to predict the expected selling revenue for different items available in the store. This will help them to manage their logistics better.

Due to certain temporary changes in the world, assume the customer buying pattern changes. For example, during the pandemic, customer started to buy extra amounts of toilet paper. If the same data starts flowing to the system, the data will be skewed as everyone is buying it. If that same feature is used in inference, system 100 will not be able to predict the sales properly because the feature values have drifted (e.g., the number of toilet paper sold per day or the average number of toilet paper bought by a customer).

Using embodiments of the invention, users would be performing feature engineering on the raw data and registering features with feature store 50 using as a prerequisite to model training and inference predictions. Feature store 50 includes offline store 312 used for model training and online store 314 used for inference (i.e., using live data input to the ML model to generate a prediction). Whenever new data enters feature store 50, a notification is send to drift detector 310 to start performing the series of tests (e.g., mean, median, mode, KS test, etc.). The tests will use the feature store historical data which has the previous pattern. The test will compare the new data and feature store historical data, which will detect some drift.

Drift detector 310 will alert an ML engineer about the possible drift and tag the data set with a “possible drift” tag. The tag can be consumed in different ways by the consumer. For example, if machine learning pipeline sees the tag in a dataset, it will not allow the data to flow to the next steps in the pipeline and model inference will not occur with the drift data and an inaccurate prediction will be avoided. Instead, system 100 can trigger the retraining of the model with the newly observed data. The ML engineer can then investigate and take the appropriate action depending upon the use case.

In contrast to embodiments of the invention, known drift detector systems generally would need some explicit validation data to detect the drift. Known systems will see the new customer pattern data and the system them needs to provide some expected patterns explicitly. If the system started training the recent temporal change in the pattern of data, then it will start making wrong predictions. For example, it might start predicting a large number of toilet paper needed, which may not be the case next week if people started buying it due to a hoax. Known systems would need some type of manual intervention to respond.

Known drift detection systems generally require users to register their training dataset and provide a list of features which are of interest to users. In order to detect drift, known systems would also need to take the unseen data (i.e., live inference data) from users and then perform statistical tests on these two datasets to detect concept or covariate drift.

In contrast to embodiments of the invention, known systems are generally reactive. For example, a new model may be trained with some drifted data and deployed in production. A user will begin using it, and then the system will detect the performance is degraded and take action. In these known systems, the users first need to invoke the inference endpoint to detect the possible degraded performance of the model due to drifted trained data, which is after the prediction event happened. In contrast, with embodiments, even if users are not using a drifted model, inference detector 320 will detect it proactively, even though no user has yet to invoke the endpoint.

As another example, assume a financial organization ML model that is provided real time data to predict/detect possible fraud detection. During the pandemic, a large number of people who have not been exposed to online shopping were forced to use it due to lockdown restrictions. Because these users have none or minimal past history, the fraud detection system is under stress because it is not able to detect between fraudulent and non-fraudulent transactions. For example, during certain timeframes people might prefer buying items from offline stores but a senior citizen may avoid online buying channels due to trust issues or because of unfamiliarity. Such data would not be present in the historical/training data so a prediction will start to go wrong (drift) in such scenarios.

In embodiments, drift detector 310 will see these new user entries as new data and not as drifted data as the tests may not find a changing pattern. For example, the mean and median values may remain substantially similar as with the previous pattern data in feature store 50. Therefore, the data will be moved to model training 328 and after that a newly trained model 326 for fraud will be deployed in production.

In this example, new data ingested into the feature store was tested and no drift was detected as the statistical nature of the data may remain same. Then, the quality gate passes the data to next steps which trains the model with new data and creates a newly trained model. This process of new data to model training is typically automated, so when new data arrives, the training steps execute to produce the new model trained on new data, which results in a new model created with newly trained data.

However, before an actual customer begins to use the newly deployed model, inference detector 320 will invoke the model prediction endpoint, using generated data or feature store data and try to predict the model performance. Inference detector 320 will then compare the model performance metrics with previous historical metrics computed on the same data (e.g., the correlation between input and target label can change between historical data and the generated data or feature store data), and if it is below a configured threshold it will (1) notify the ML engineer and (2) mark the model deployment with a “possible drifted deployment” tag. The system then can roll back the model deployment or block users from accessing this model.

Therefore, with embodiments, this detection happens even before actual users start using the new endpoint. This is proactive action (before the customer sees it) rather than reactive.

In contrast, known drift detection systems generally implement a reactive approach, by waiting until users start seeing deteriorated model performance, not before.

Example Cloud Infrastructure

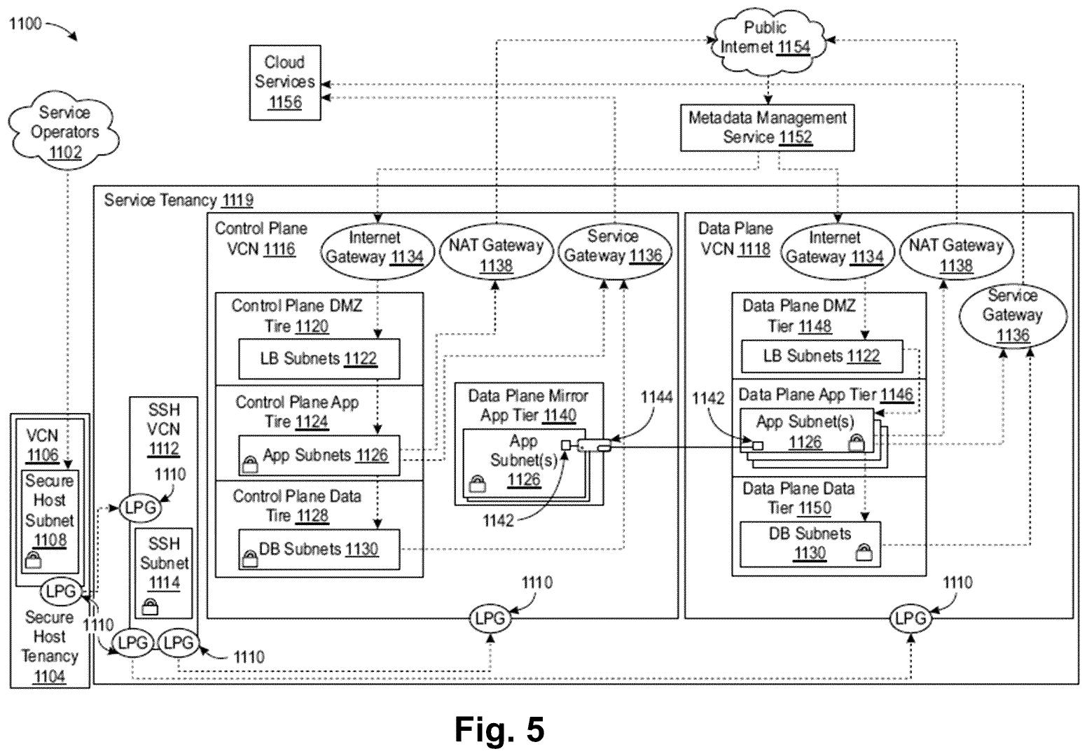

FIGS. 5-8 illustrate an example cloud infrastructure that can incorporate the secure on-premises to cloud connector framework system in accordance to embodiments. The cloud infrastructure of FIG. 5-8 can be used to implement network/cloud 104 of FIG. 1 and host ML data and inference drift detection layer system 10.

As disclosed above, infrastructure as a service (“IaaS”) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance.

In some instances, IaaS customers may access resources and services through a wide area network (“WAN”), such as the Internet, and can use the cloud provider's services to install the remaining elements of an application stack. For example, the user can log in to the IaaS platform to create virtual machines (“VM”s), install operating systems (“OS”s) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different problems for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (“VPC”s) (e.g., a potentially on-demand pool of configurable and/or shared computing resources), also known as a core network. In some examples, there may also be one or more security group rules provisioned to define how the security of the network will be set up and one or more virtual machines. Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 5 is a block diagram 1100 illustrating an example pattern of an IaaS architecture, according to at least one embodiment. Service operators 1102 can be communicatively coupled to a secure host tenancy 1104 that can include a virtual cloud network (“VCN”) 1106 and a secure host subnet 1108. In some examples, the service operators 1102 may be using one or more client computing devices, which may be portable handheld devices (e.g., an iPhone®, cellular telephone, an iPad®, computing tablet, a personal digital assistant (“PDA”)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (“SMS”), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1106 and/or the Internet.

The VCN 1106 can include a local peering gateway (“LPG”) 1110 that can be communicatively coupled to a secure shell (“SSH”) VCN 1112 via an LPG 1110 contained in the SSH VCN 1112. The SSH VCN 1112 can include an SSH subnet 1114, and the SSH VCN 1112 can be communicatively coupled to a control plane VCN 1116 via the LPG 1110 contained in the control plane VCN 1116. Also, the SSH VCN 1112 can be communicatively coupled to a data plane VCN 1118 via an LPG 1110. The control plane VCN 1116 and the data plane VCN 1118 can be contained in a service tenancy 1119 that can be owned and/or operated by the IaaS provider.

The control plane VCN 1116 can include a control plane demilitarized zone (“DMZ”) tier 1120 that acts as a perimeter network (e.g., portions of a corporate network between the corporate intranet and external networks). The DMZ-based servers may have restricted responsibilities and help keep security breaches contained. Additionally, the DMZ tier 1120 can include one or more load balancer (“LB”) subnet(s) 1122, a control plane app tier 1124 that can include app subnet(s) 1126, a control plane data tier 1128 that can include database (DB) subnet(s) 1130 (e.g., frontend DB subnet(s) and/or backend DB subnet(s)). The LB subnet(s) 1122 contained in the control plane DMZ tier 1120 can be communicatively coupled to the app subnet(s) 1126 contained in the control plane app tier 1124 and an Internet gateway 1134 that can be contained in the control plane VCN 1116, and the app subnet(s) 1126 can be communicatively coupled to the DB subnet(s) 1130 contained in the control plane data tier 1128 and a service gateway 1136 and a network address translation (NAT) gateway 1138. The control plane VCN 1116 can include the service gateway 1136 and the NAT gateway 1138.

The control plane VCN 1116 can include a data plane mirror app tier 1140 that can include app subnet(s) 1126. The app subnet(s) 1126 contained in the data plane mirror app tier 1140 can include a virtual network interface controller (VNIC) 1142 that can execute a compute instance 1144. The compute instance 1144 can communicatively couple the app subnet(s) 1126 of the data plane mirror app tier 1140 to app subnet(s) 1126 that can be contained in a data plane app tier 1146.

The data plane VCN 1118 can include the data plane app tier 1146, a data plane DMZ tier 1148, and a data plane data tier 1150. The data plane DMZ tier 1148 can include LB subnet(s) 1122 that can be communicatively coupled to the app subnet(s) 1126 of the data plane app tier 1146 and the Internet gateway 1134 of the data plane VCN 1118. The app subnet(s) 1126 can be communicatively coupled to the service gateway 1136 of the data plane VCN 1118 and the NAT gateway 1138 of the data plane VCN 1118. The data plane data tier 1150 can also include the DB subnet(s) 1130 that can be communicatively coupled to the app subnet(s) 1126 of the data plane app tier 1146.

The Internet gateway 1134 of the control plane VCN 1116 and of the data plane VCN 1118 can be communicatively coupled to a metadata management service 1152 that can be communicatively coupled to public Internet 1154. Public Internet 1154 can be communicatively coupled to the NAT gateway 1138 of the control plane VCN 1116 and of the data plane VCN 1118. The service gateway 1136 of the control plane VCN 1116 and of the data plane VCN 1118 can be communicatively coupled to cloud services 1156.

In some examples, the service gateway 1136 of the control plane VCN 1116 or of the data plane VCN 1118 can make application programming interface (“API”) calls to cloud services 1156 without going through public Internet 1154. The API calls to cloud services 1156 from the service gateway 1136 can be one-way: the service gateway 1136 can make API calls to cloud services 1156, and cloud services 1156 can send requested data to the service gateway 1136. But, cloud services 1156 may not initiate API calls to the service gateway 1136.

In some examples, the secure host tenancy 1104 can be directly connected to the service tenancy 1119, which may be otherwise isolated. The secure host subnet 1108 can communicate with the SSH subnet 1114 through an LPG 1110 that may enable two-way communication over an otherwise isolated system. Connecting the secure host subnet 1108 to the SSH subnet 1114 may give the secure host subnet 1108 access to other entities within the service tenancy 1119.

The control plane VCN 1116 may allow users of the service tenancy 1119 to set up or otherwise provision desired resources. Desired resources provisioned in the control plane VCN 1116 may be deployed or otherwise used in the data plane VCN 1118. In some examples, the control plane VCN 1116 can be isolated from the data plane VCN 1118, and the data plane mirror app tier 1140 of the control plane VCN 1116 can communicate with the data plane app tier 1146 of the data plane VCN 1118 via VNICs 1142 that can be contained in the data plane mirror app tier 1140 and the data plane app tier 1146.

In some examples, users of the system, or customers, can make requests, for example create, read, update, or delete (“CRUD”) operations, through public Internet 1154 that can communicate the requests to the metadata management service 1152. The metadata management service 1152 can communicate the request to the control plane VCN 1116 through the Internet gateway 1134. The request can be received by the LB subnet(s) 1122 contained in the control plane DMZ tier 1120. The LB subnet(s) 1122 may determine that the request is valid, and in response to this determination, the LB subnet(s) 1122 can transmit the request to app subnet(s) 1126 contained in the control plane app tier 1124. If the request is validated and requires a call to public Internet 1154, the call to public Internet 1154 may be transmitted to the NAT gateway 1138 that can make the call to public Internet 1154. Memory that may be desired to be stored by the request can be stored in the DB subnet(s) 1130.

In some examples, the data plane mirror app tier 1140 can facilitate direct communication between the control plane VCN 1116 and the data plane VCN 1118. For example, changes, updates, or other suitable modifications to configuration may be desired to be applied to the resources contained in the data plane VCN 1118. Via a VNIC 1142, the control plane VCN 1116 can directly communicate with, and can thereby execute the changes, updates, or other suitable modifications to configuration to, resources contained in the data plane VCN 1118.

In some embodiments, the control plane VCN 1116 and the data plane VCN 1118 can be contained in the service tenancy 1119. In this case, the user, or the customer, of the system may not own or operate either the control plane VCN 1116 or the data plane VCN 1118. Instead, the IaaS provider may own or operate the control plane VCN 1116 and the data plane VCN 1118, both of which may be contained in the service tenancy 1119. This embodiment can enable isolation of networks that may prevent users or customers from interacting with other users', or other customers', resources. Also, this embodiment may allow users or customers of the system to store databases privately without needing to rely on public Internet 1154, which may not have a desired level of security, for storage.

In other embodiments, the LB subnet(s) 1122 contained in the control plane VCN 1116 can be configured to receive a signal from the service gateway 1136. In this embodiment, the control plane VCN 1116 and the data plane VCN 1118 may be configured to be called by a customer of the IaaS provider without calling public Internet 1154. Customers of the IaaS provider may desire this embodiment since database(s) that the customers use may be controlled by the IaaS provider and may be stored on the service tenancy 1119, which may be isolated from public Internet 1154.

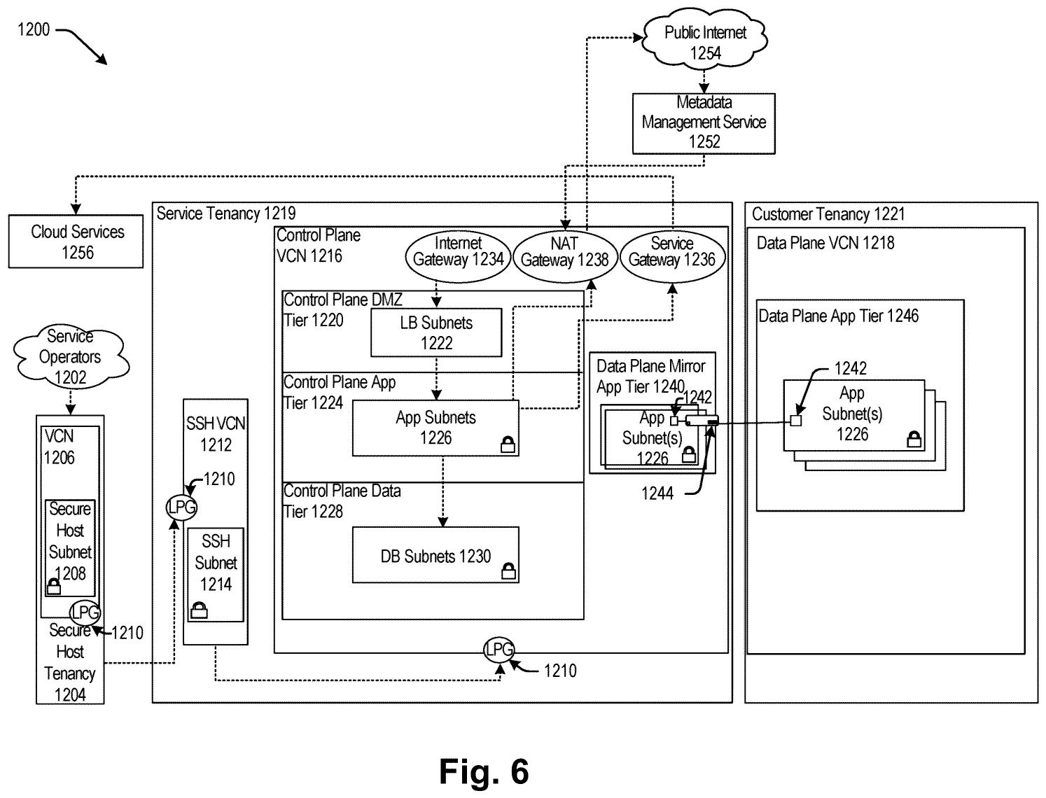

FIG. 6 is a block diagram 1200 illustrating another example pattern of an IaaS architecture, according to at least one embodiment. Service operators 1202 (e.g. service operators 1102) can be communicatively coupled to a secure host tenancy 1204 (e.g. the secure host tenancy 1104) that can include a virtual cloud network (VCN) 1206 (e.g. the VCN 1106) and a secure host subnet 1208 (e.g. the secure host subnet 1108). The VCN 1206 can include a local peering gateway (LPG) 1210 (e.g. the LPG 1110) that can be communicatively coupled to a secure shell (SSH) VCN 1212 (e.g. the SSH VCN 1112 10) via an LPG 1110 contained in the SSH VCN 1212. The SSH VCN 1212 can include an SSH subnet 1214 (e.g. the SSH subnet 1114), and the SSH VCN 1212 can be communicatively coupled to a control plane VCN 1216 (e.g. the control plane VCN 1116) via an LPG 1210 contained in the control plane VCN 1216. The control plane VCN 1216 can be contained in a service tenancy 1219 (e.g. the service tenancy 1119), and the data plane VCN 1218 (e.g. the data plane VCN 1118) can be contained in a customer tenancy 1221 that may be owned or operated by users, or customers, of the system.

The control plane VCN 1216 can include a control plane DMZ tier 1220 (e.g. the control plane DMZ tier 1120) that can include LB subnet(s) 1222 (e.g. LB subnet(s) 1122), a control plane app tier 1224 (e.g. the control plane app tier 1124) that can include app subnet(s) 1226 (e.g. app subnet(s) 1126), a control plane data tier 1228 (e.g. the control plane data tier 1128) that can include database (DB) subnet(s) 1230 (e.g. similar to DB subnet(s) 1130). The LB subnet(s) 1222 contained in the control plane DMZ tier 1220 can be communicatively coupled to the app subnet(s) 1226 contained in the control plane app tier 1224 and an Internet gateway 1234 (e.g. the Internet gateway 1134) that can be contained in the control plane VCN 1216, and the app subnet(s) 1226 can be communicatively coupled to the DB subnet(s) 1230 contained in the control plane data tier 1228 and a service gateway 1236 and a network address translation (NAT) gateway 1238 (e.g. the NAT gateway 1138). The control plane VCN 1216 can include the service gateway 1236 and the NAT gateway 1238.

The control plane VCN 1216 can include a data plane mirror app tier 1240 (e.g. the data plane mirror app tier 1140) that can include app subnet(s) 1226. The app subnet(s) 1226 contained in the data plane mirror app tier 1240 can include a virtual network interface controller (VNIC) 1242 (e.g. the VNIC of 1142) that can execute a compute instance 1244 (e.g. similar to the compute instance 1144). The compute instance 1244 can facilitate communication between the app subnet(s) 1226 of the data plane mirror app tier 1240 and the app subnet(s) 1226 that can be contained in a data plane app tier 1246 (e.g. the data plane app tier 1146) via the VNIC 1242 contained in the data plane mirror app tier 1240 and the VNIC 1242 contained in the data plane app tier 1246.

The Internet gateway 1234 contained in the control plane VCN 1216 can be communicatively coupled to a metadata management service 1252 (e.g. the metadata management service 1152) that can be communicatively coupled to public Internet 1254 (e.g. public Internet 1154). Public Internet 1254 can be communicatively coupled to the NAT gateway 1238 contained in the control plane VCN 1216. The service gateway 1236 contained in the control plane VCN 1216 can be communicatively couple to cloud services 1256 (e.g. cloud services 1156).

In some examples, the data plane VCN 1218 can be contained in the customer tenancy 1221. In this case, the IaaS provider may provide the control plane VCN 1216 for each customer, and the IaaS provider may, for each customer, set up a unique compute instance 1244 that is contained in the service tenancy 1219. Each compute instance 1244 may allow communication between the control plane VCN 1216, contained in the service tenancy 1219, and the data plane VCN 1218 that is contained in the customer tenancy 1221. The compute instance 1244 may allow resources that are provisioned in the control plane VCN 1216 that is contained in the service tenancy 1219, to be deployed or otherwise used in the data plane VCN 1218 that is contained in the customer tenancy 1221.

In other examples, the customer of the IaaS provider may have databases that live in the customer tenancy 1221. In this example, the control plane VCN 1216 can include the data plane mirror app tier 1240 that can include app subnet(s) 1226. The data plane mirror app tier 1240 can reside in the data plane VCN 1218, but the data plane mirror app tier 1240 may not live in the data plane VCN 1218. That is, the data plane mirror app tier 1240 may have access to the customer tenancy 1221, but the data plane mirror app tier 1240 may not exist in the data plane VCN 1218 or be owned or operated by the customer of the IaaS provider. The data plane mirror app tier 1240 may be configured to make calls to the data plane VCN 1218, but may not be configured to make calls to any entity contained in the control plane VCN 1216. The customer may desire to deploy or otherwise use resources in the data plane VCN 1218 that are provisioned in the control plane VCN 1216, and the data plane mirror app tier 1240 can facilitate the desired deployment, or other usage of resources, of the customer.

In some embodiments, the customer of the IaaS provider can apply filters to the data plane VCN 1218. In this embodiment, the customer can determine what the data plane VCN 1218 can access, and the customer may restrict access to public Internet 1254 from the data plane VCN 1218. The IaaS provider may not be able to apply filters or otherwise control access of the data plane VCN 1218 to any outside networks or databases. Applying filters and controls by the customer onto the data plane VCN 1218, contained in the customer tenancy 1221, can help isolate the data plane VCN 1218 from other customers and from public Internet 1254.

In some embodiments, cloud services 1256 can be called by the service gateway 1236 to access services that may not exist on public Internet 1254, on the control plane VCN 1216, or on the data plane VCN 1218. The connection between cloud services 1256 and the control plane VCN 1216 or the data plane VCN 1218 may not be live or continuous. Cloud services 1256 may exist on a different network owned or operated by the IaaS provider. Cloud services 1256 may be configured to receive calls from the service gateway 1236 and may be configured to not receive calls from public Internet 1254. Some cloud services 1256 may be isolated from other cloud services 1256, and the control plane VCN 1216 may be isolated from cloud services 1256 that may not be in the same region as the control plane VCN 1216. For example, the control plane VCN 1216 may be located in “Region 1,” and cloud service “Deployment 8,” may be located in Region 1 and in “Region 2.” If a call to Deployment 8 is made by the service gateway 1236 contained in the control plane VCN 1216 located in Region 1, the call may be transmitted to Deployment 8 in Region 1. In this example, the control plane VCN 1216, or Deployment 8 in Region 1, may not be communicatively coupled to, or otherwise in communication with, Deployment 8 in Region 2.

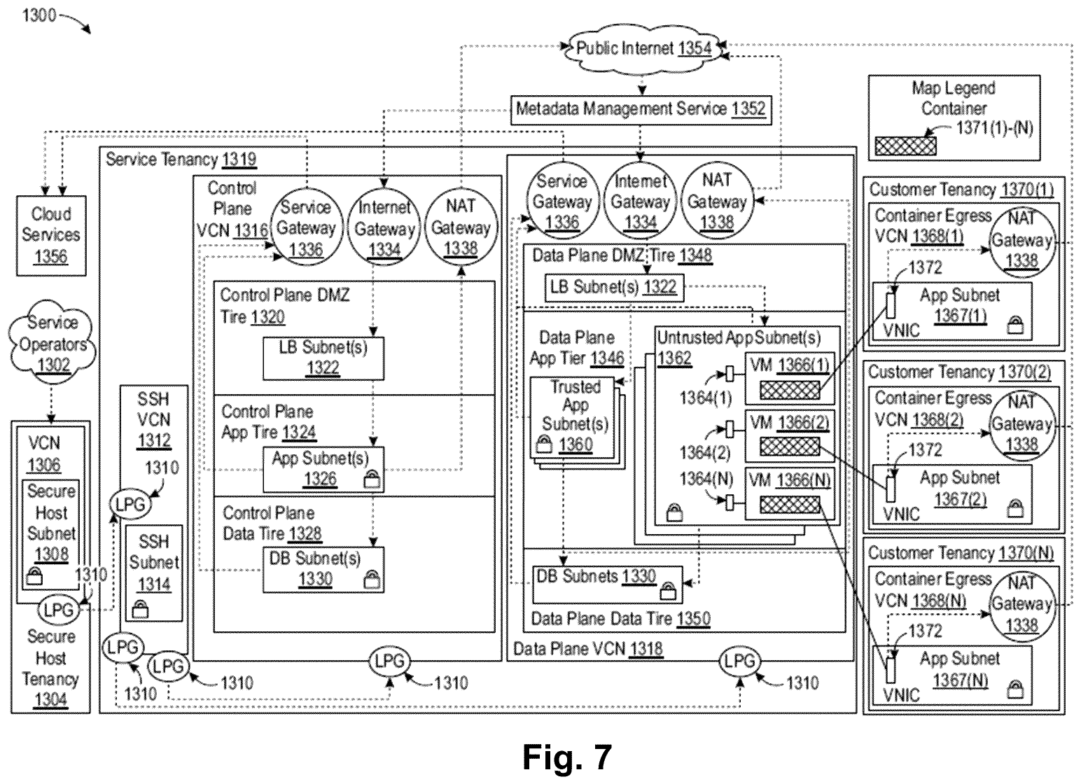

FIG. 7 is a block diagram 1300 illustrating another example pattern of an IaaS architecture, according to at least one embodiment. Service operators 1302 (e.g. service operators 1102) can be communicatively coupled to a secure host tenancy 1304 (e.g. the secure host tenancy 1104) that can include a virtual cloud network (VCN) 1306 (e.g. the VCN 1106) and a secure host subnet 1308 (e.g. the secure host subnet 1108). The VCN 1306 can include an LPG 1310 (e.g. the LPG 1110) that can be communicatively coupled to an SSH VCN 1312 (e.g. the SSH VCN 1112) via an LPG 1310 contained in the SSH VCN 1312. The SSH VCN 1312 can include an SSH subnet 1314 (e.g. the SSH subnet 1114), and the SSH VCN 1312 can be communicatively coupled to a control plane VCN 1316 (e.g. the control plane VCN 1116) via an LPG 1310 contained in the control plane VCN 1316 and to a data plane VCN 1318 (e.g. the data plane 1118) via an LPG 1310 contained in the data plane VCN 1318. The control plane VCN 1316 and the data plane VCN 1318 can be contained in a service tenancy 1319 (e.g. the service tenancy 1119).

The control plane VCN 1316 can include a control plane DMZ tier 1320 (e.g. the control plane DMZ tier 1120) that can include load balancer (“LB”) subnet(s) 1322 (e.g. LB subnet(s) 1122), a control plane app tier 1324 (e.g. the control plane app tier 1124) that can include app subnet(s) 1326 (e.g. similar to app subnet(s) 1126), a control plane data tier 1328 (e.g. the control plane data tier 1128) that can include DB subnet(s) 1330. The LB subnet(s) 1322 contained in the control plane DMZ tier 1320 can be communicatively coupled to the app subnet(s) 1326 contained in the control plane app tier 1324 and to an Internet gateway 1334 (e.g. the Internet gateway 1134) that can be contained in the control plane VCN 1316, and the app subnet(s) 1326 can be communicatively coupled to the DB subnet(s) 1330 contained in the control plane data tier 1328 and to a service gateway 1336 (e.g. the service gateway) and a network address translation (NAT) gateway 1338 (e.g. the NAT gateway 1138). The control plane VCN 1316 can include the service gateway 1336 and the NAT gateway 1338.

The data plane VCN 1318 can include a data plane app tier 1346 (e.g. the data plane app tier 1146), a data plane DMZ tier 1348 (e.g. the data plane DMZ tier 1148), and a data plane data tier 1350 (e.g. the data plane data tier 1150 of FIG. 11). The data plane DMZ tier 1348 can include LB subnet(s) 1322 that can be communicatively coupled to trusted app subnet(s) 1360 and untrusted app subnet(s) 1362 of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include one or more primary VNICs 1364(1)-(N) that can be communicatively coupled to tenant virtual machines (VMs) 1366(1)-(N). Each tenant VM 1366(1)-(N) can be communicatively coupled to a respective app subnet 1367(1)-(N) that can be contained in respective container egress VCNs 1368(1)-(N) that can be contained in respective customer tenancies 1370(1)-(N). Respective secondary VNICs 1372(1)-(N) can facilitate communication between the untrusted app subnet(s) 1362 contained in the data plane VCN 1318 and the app subnet contained in the container egress VCNs 1368(1)-(N). Each container egress VCNs 1368(1)-(N) can include a NAT gateway 1338 that can be communicatively coupled to public Internet 1354 (e.g. public Internet 1154).

The Internet gateway 1334 contained in the control plane VCN 1316 and contained in the data plane VCN 1318 can be communicatively coupled to a metadata management service 1352 (e.g. the metadata management system 1152) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively couple to cloud services 1356.

In some embodiments, the data plane VCN 1318 can be integrated with customer tenancies 1370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane tier app 1346. Code to run the function may be executed in the VMs 1366(1)-(N), and the code may not be configured to run anywhere else on the data plane VCN 1318. Each VM 1366(1)-(N) may be connected to one customer tenancy 1370. Respective containers 1371(1)-(N) contained in the VMs 1366(1)-(N) may be configured to run the code. In this case, there can be a dual isolation (e.g., the containers 1371(1)-(N) running code, where the containers 1371(1)-(N) may be contained in at least the VM 1366(1)-(N) that are contained in the untrusted app subnet(s) 1362), which may help prevent incorrect or otherwise undesirable code from damaging the network of the IaaS provider or from damaging a network of a different customer. The containers 1371(1)-(N) may be communicatively coupled to the customer tenancy 1370 and may be configured to transmit or receive data from the customer tenancy 1370. The containers 1371(1)-(N) may not be configured to transmit or receive data from any other entity in the data plane VCN 1318. Upon completion of running the code, the IaaS provider may kill or otherwise dispose of the containers 1371(1)-(N).

In some embodiments, the trusted app subnet(s) 1360 may run code that may be owned or operated by the IaaS provider. In this embodiment, the trusted app subnet(s) 1360 may be communicatively coupled to the DB subnet(s) 1330 and be configured to execute CRUD operations in the DB subnet(s) 1330. The untrusted app subnet(s) 1362 may be communicatively coupled to the DB subnet(s) 1330, but in this embodiment, the untrusted app subnet(s) may be configured to execute read operations in the DB subnet(s) 1330. The containers 1371(1)-(N) that can be contained in the VM 1366(1)-(N) of each customer and that may run code from the customer may not be communicatively coupled with the DB subnet(s) 1330.

In other embodiments, the control plane VCN 1316 and the data plane VCN 1318 may not be directly communicatively coupled. In this embodiment, there may be no direct communication between the control plane VCN 1316 and the data plane VCN 1318. However, communication can occur indirectly through at least one method. An LPG 1310 may be established by the IaaS provider that can facilitate communication between the control plane VCN 1316 and the data plane VCN 1318. In another example, the control plane VCN 1316 or the data plane VCN 1318 can make a call to cloud services 1356 via the service gateway 1336. For example, a call to cloud services 1356 from the control plane VCN 1316 can include a request for a service that can communicate with the data plane VCN 1318.

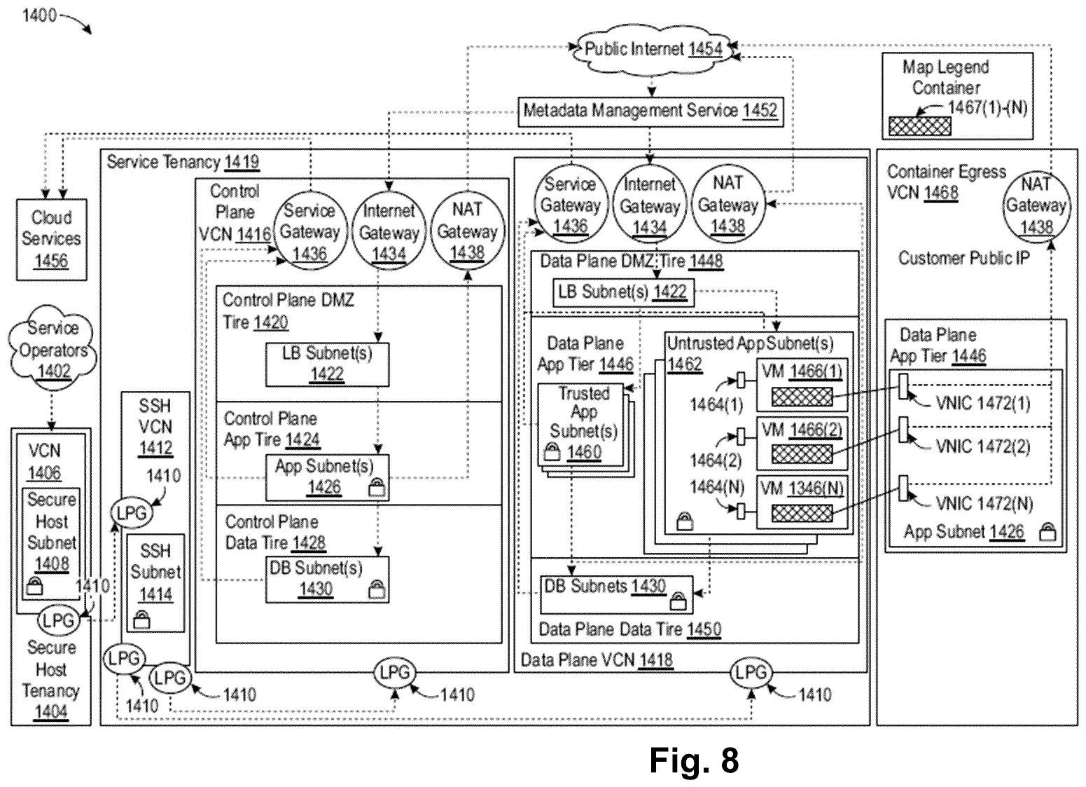

FIG. 8 is a block diagram 1400 illustrating another example pattern of an IaaS architecture, according to at least one embodiment. Service operators 1402 (e.g. service operators 1102) can be communicatively coupled to a secure host tenancy 1404 (e.g. the secure host tenancy 1104) that can include a virtual cloud network (“VCN”) 1406 (e.g. the VCN 1106) and a secure host subnet 1408 (e.g. the secure host subnet 1108). The VCN 1406 can include an LPG 1410 (e.g. the LPG 1110) that can be communicatively coupled to an SSH VCN 1412 (e.g. the SSH VCN 1112) via an LPG 1410 contained in the SSH VCN 1412. The SSH VCN 1412 can include an SSH subnet 1414 (e.g. the SSH subnet 1114), and the SSH VCN 1412 can be communicatively coupled to a control plane VCN 1416 (e.g. the control plane VCN 1116) via an LPG 1410 contained in the control plane VCN 1416 and to a data plane VCN 1418 (e.g. the data plane 1118) via an LPG 1410 contained in the data plane VCN 1418. The control plane VCN 1416 and the data plane VCN 1418 can be contained in a service tenancy 1419 (e.g. the service tenancy 1119).

The control plane VCN 1416 can include a control plane DMZ tier 1420 (e.g. the control plane DMZ tier 1120) that can include LB subnet(s) 1422 (e.g. LB subnet(s) 1122), a control plane app tier 1424 (e.g. the control plane app tier 1124) that can include app subnet(s) 1426 (e.g. app subnet(s) 1126), a control plane data tier 1428 (e.g. the control plane data tier 1128) that can include DB subnet(s) 1430 (e.g. DB subnet(s) 1330). The LB subnet(s) 1422 contained in the control plane DMZ tier 1420 can be communicatively coupled to the app subnet(s) 1426 contained in the control plane app tier 1424 and to an Internet gateway 1434 (e.g. the Internet gateway 1134) that can be contained in the control plane VCN 1416, and the app subnet(s) 1426 can be communicatively coupled to the DB subnet(s) 1430 contained in the control plane data tier 1428 and to a service gateway 1436 (e.g. the service gateway of FIG. 11) and a network address translation (NAT) gateway 1438 (e.g. the NAT gateway 1138 of FIG. 11). The control plane VCN 1416 can include the service gateway 1436 and the NAT gateway 1438.

The data plane VCN 1418 can include a data plane app tier 1446 (e.g. the data plane app tier 1146), a data plane DMZ tier 1448 (e.g. the data plane DMZ tier 1148), and a data plane data tier 1450 (e.g. the data plane data tier 1150). The data plane DMZ tier 1448 can include LB subnet(s) 1422 that can be communicatively coupled to trusted app subnet(s) 1460 (e.g. trusted app subnet(s) 1360) and untrusted app subnet(s) 1462 (e.g. untrusted app subnet(s) 1362) of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include primary VNICs 1464(1)-(N) that can be communicatively coupled to tenant virtual machines (VMs) 1466(1)-(N) residing within the untrusted app subnet(s) 1462. Each tenant VM 1466(1)-(N) can run code in a respective container 1467(1)-(N), and be communicatively coupled to an app subnet 1426 that can be contained in a data plane app tier 1446 that can be contained in a container egress VCN 1468. Respective secondary VNICs 1472(1)-(N) can facilitate communication between the untrusted app subnet(s) 1462 contained in the data plane VCN 1418 and the app subnet contained in the container egress VCN 1468. The container egress VCN can include a NAT gateway 1438 that can be communicatively coupled to public Internet 1454 (e.g. public Internet 1154).

The Internet gateway 1434 contained in the control plane VCN 1416 and contained in the data plane VCN 1418 can be communicatively coupled to a metadata management service 1452 (e.g. the metadata management system 1152) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively couple to cloud services 1456.

In some examples, the pattern illustrated by the architecture of block diagram 1400 of FIG. 7 may be considered an exception to the pattern illustrated by the architecture of block diagram 1300 of FIG. 6 and may be desirable for a customer of the IaaS provider if the IaaS provider cannot directly communicate with the customer (e.g., a disconnected region). The respective containers 1467(1)-(N) that are contained in the VMs 1466(1)-(N) for each customer can be accessed in real-time by the customer. The containers 1467(1)-(N) may be configured to make calls to respective secondary VNICs 1472(1)-(N) contained in app subnet(s) 1426 of the data plane app tier 1446 that can be contained in the container egress VCN 1468. The secondary VNICs 1472(1)-(N) can transmit the calls to the NAT gateway 1438 that may transmit the calls to public Internet 1454. In this example, the containers 1467(1)-(N) that can be accessed in real-time by the customer can be isolated from the control plane VCN 1416 and can be isolated from other entities contained in the data plane VCN 1418. The containers 1467(1)-(N) may also be isolated from resources from other customers.

In other examples, the customer can use the containers 1467(1)-(N) to call cloud services 1456. In this example, the customer may run code in the containers 1467(1)-(N) that requests a service from cloud services 1456. The containers 1467(1)-(N) can transmit this request to the secondary VNICs 1472(1)-(N) that can transmit the request to the NAT gateway that can transmit the request to public Internet 1454. Public Internet 1454 can transmit the request to LB subnet(s) 1422 contained in the control plane VCN 1416 via the Internet gateway 1434. In response to determining the request is valid, the LB subnet(s) can transmit the request to app subnet(s) 1426 that can transmit the request to cloud services 1456 via the service gateway 1436.

It should be appreciated that IaaS architectures 1100, 1200, 1300, 1400 depicted in the figures may have other components than those depicted. Further, the embodiments shown in the figures are only some examples of a cloud infrastructure system that may incorporate certain embodiments. In some other embodiments, the IaaS systems may have more or fewer components than shown in the figures, may combine two or more components, or may have a different configuration or arrangement of components.

As disclosed, embodiments detect data draft at a feature store and, if detected, prevent the drifted data to be used to train a model. Further, embodiments detect data drift for a trained model, and if detected, prevent the trained model from providing predictions in response to inference requests.

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure. In order to determine the metes and bounds of the disclosure, therefore, reference should be made to the appended claims.

What is claimed is:

1. A method of detecting data drift associated with machine learning (ML) models, the method comprising:
identifying a first feature stored by a feature store, wherein the feature store comprises an offline store and an online store;
determining one or more first trained ML models that are using the first feature;
for each of the first trained ML models:
invoking the first trained ML model using synthetic data or validation data;
generating metrics to determine an accuracy of the first trained ML model; and
when the accuracy is below a threshold, generating an alert notifying of a first data drift for the first trained ML model.

2. The method of claim 1, further comprising:
for a second feature, determining new feature values ingested by the offline store of the feature store;
determining an occurrence of a second data drift between the new feature values and previous corresponding feature values; and
in response to the determining, labeling the second feature and preventing the second feature from being used to train a second ML model.

3. The method of claim 2, wherein the determining the second data drift comprises determining mean, median and mode between the new feature values and previous corresponding feature values.

4. The method of claim 1, wherein invoking the first trained ML model comprises accessing a representational state transfer application programming interface (REST API) server with an inference request.

5. The method of claim 2, further comprising converting data from one or more data sources into the second feature.

6. The method of claim 2, wherein the labeling the second feature is implemented by the feature store.

7. The method of claim 1, wherein the metrics comprise determining if an area under an ROC curve is below a threshold.

8. The method of claim 2, the preventing the second feature from being used to train the second ML model comprising a gate between the offline store and the second ML model.

9. A computer readable medium having instructions stored thereon that, when executed by one or more processors, cause the processors to detect data drift associated with machine learning (ML) models, the detecting comprising:
identifying a first feature stored by a feature store, wherein the feature store comprises an offline store and an online store;
determining one or more first trained ML models that are using the first feature;
for each of the first trained ML models:
invoking the first trained ML model using synthetic data or validation data;
generating metrics to determine an accuracy of the first trained ML model; and
when the accuracy is below a threshold, generating an alert notifying of a first data drift for the first trained ML model.

10. The computer readable medium of claim 9, the detecting further comprising:
for a second feature, determining new feature values ingested by the offline store of the feature store;
determining an occurrence of a second data drift between the new feature values and previous corresponding feature values; and
in response to the determining, labeling the second feature and preventing the second feature from being used to train a second ML model.

11. The computer readable medium of claim 10, wherein the determining the second data drift comprises determining mean, median and mode between the new feature values and previous corresponding feature values.

12. The computer readable medium of claim 9, wherein invoking the first trained ML model comprises accessing a representational state transfer application programing interface (REST API) server with an inference request.

13. The computer readable medium of claim 10, the detecting further comprising converting data from one or more data sources into the second feature.

14. The computer readable medium of claim 10, wherein the labeling the second feature is implemented by the feature store.

15. The computer readable medium of claim 9, wherein the metrics comprise determining if an area under an ROC curve is below a threshold.

16. The computer readable medium of claim 10, the preventing the second feature from being used to train the second ML model comprising a gate between the offline store and the second ML model.

17. A cloud infrastructure comprising:
a plurality of machine learning (ML) models;
a feature store comprising an offline store and an online store;
a data drift layer coupled to the feature store configured to detect data drift associated with the ML models, the detecting comprising:
identifying a first feature stored by a feature store, wherein the feature store comprises an offline store and an online store;
determining one or more first trained ML models that are using the first feature;
for each of the first trained ML models:
invoking the first trained ML model using synthetic data or validation data;
generating metrics to determine an accuracy of the first trained ML model; and
when the accuracy is below a threshold, generating an alert notifying of a first data drift for the first trained ML model.

18. The cloud infrastructure of claim 17, the detecting further comprising:
for a second feature, determining new feature values ingested by the offline store of the feature store;
determining an occurrence of a second data drift between the new feature values and previous corresponding feature values; and
in response to the determining, labeling the second feature and preventing the second feature from being used to train a second ML model.

19. The cloud infrastructure of claim 18, wherein the determining the second data drift comprises determining mean, median and mode between the new feature values and previous corresponding feature values.

20. The cloud infrastructure of claim 17, wherein invoking the first trained ML model comprises accessing a representational state transfer application programming interface (REST API) server with an inference request.
